(19) United States
(12) Patent Application Publication
(10) Pub. No.: US 2008/0043571 A1
(43) Pub. Date: Feb. 21, 2008

(54) MIXING HOE AND BLADE

(75) Inventors: Daniel Lee Bizzell, Davidson, NC (US); Chris Hoy, Charlotte, NC (US); Ian D. Kovacevich, Charlotte, NC (US); Davin Mortenson, Huntersville, NC (US)

Correspondence Address: TILLMAN WRIGHT, PLLC, P.O. BOX 471581, CHARLOTTE, NC, 28247, US

(73) Assignee: VICIOUS TOOLS, LLC, Charlotte, NC (US)

(21) Appl. No.: 11/764,688

(22) Filed: Jun. 18, 2007

Related U.S. Application Data
(60) Provisional application No. 60/805,083, filed on Jun. 18, 2006.

(51) Int. Cl. B01F 13/00

(52) U.S. Cl. 366/343

(57) ABSTRACT

A mixing tool includes: an elongate shaft having a longitudinal axis; and a mixing blade located at an end of the shaft, the mixing blade having a bottom, a top, two sides, and a mixing blade face disposed therebetween. Two flow ports each including an opening is disposed in the mixing blade face for flow therethrough of material being mixed by the mixing blade. Each flow port further includes a flow deflector for deflecting material flow through the opening toward the axis of the shaft. The deflected flows are convergent. The flow port is located closer to the bottom than to the top of the mixing blade. An end cap includes a gripping surface located in a radial direction further from the longitudinal axis than a gripping surface of the shaft. The center of gravity of the mixing blade lies approximately along the longitudinal axis of the shaft.

### I. CROSS-REFERENCE TO RELATED APPLICATION

The present application is a U.S. nonprovisional patent application of, and claims priority under 35 U.S.C. §119(e) to, U.S. provisional patent application Ser. No. 60/805,083, filed Jun. 18, 2006, which provisional patent application is incorporated by reference herein.

### II. COPYRIGHT STATEMENT

All of the material in this patent document is subject to copyright protection under the copyright laws of the United States and of other countries. The copyright owner has no objection to the facsimile reproduction by anyone of the patent document or the patent disclosure, as it appears in governmental files or records, but otherwise reserves all copyright rights whatsoever.

### III. BACKGROUND OF THE INVENTION

The field of the invention relates to a mixing hoe and, in particular, to a mixing hoe for mortar or other construction materials that are mixed in a container, such as a wheel barrow or other open mixing container.

Generally, it is known to use a mixing hoe to mix mortar in a wheel barrow or open container. Such practice is utilized by both professional contractors and do-it-yourself handymen. When using the mixing hoe, a user generally forms a pile or heap of powder material, such as a concrete or a sand mix from a prepackaged bag, in a container; pours in a liquid, generally water; and mixes the powder material and the water together to form a paste. This process is repeated until the proper liquid mix proportion is reached. A common problem is relates to uniformly mixing together all of the powder material. Specifically, the problem is removing all of the powder material from the corners, sides, end and bottom of the container in which the mixing is taking place, where it tends to adhere and coagulate without properly mixing with the liquid. Without complete mixing of the material, there will be some areas of the mixture where there is too much liquid and other areas where there is not enough liquid. Both situations result in a weakened structure.

U.S. Pat. No. 6,564,881 (the '881 patent), which is hereby incorporated by reference herein, discloses and describes in detail a mixing tool. Generally, the mixing tool of the '881 patent includes a standard elongate shaft having a free end, for being grasped by a user, and another end, including a metal ferrule and a mounting hook, to which a blade is attached. The blade has opposing top and bottom edges and opposing side edges. The top edge is provided with a centrally-disposed top edge recess for attaching the blade to the shaft. The blade includes a pair of spaced-apart flow ports adapted for passage of material there through during mixing. Flow deflectors are disposed adjacent the flow ports as shown in FIGS. 2-3 of the '881 patent, and serve to direct material flow toward the side edges of the mixing tool during pushing movement of the tool through the mixing material. Alternatively, flow deflectors are disposed adjacent the flow ports as shown in FIGS. 7-8 of the '881 patent, and serve to direct material flow toward the top edge of the mixing tool during pushing movement of the tool through the mixing material.

The '881 patent provided an improved design and operational advantages over the mixing hoes available at the time of the invention of the '881 patent. While the invention of the '881 patent certainly is simple in design and elegant in use, the present invention is believed to provide yet further improvements and operational advantages over the mixing tool of the '881 patent.

### IV. SUMMARY OF THE INVENTION

The present invention includes many aspects and features.

In accordance with an aspect of the invention, a mixing tool includes: an elongate shaft having a longitudinal axis; and a mixing blade located at an end of the shaft, the mixing blade having a bottom, a top, two sides, and a mixing blade face disposed therebetween. In further accordance with this aspect, a flow port comprising an opening is disposed in the mixing blade face for flow therethrough of material being mixed by the mixing blade. The flow port further includes a flow deflector for deflecting material flow through the opening toward the axis of the shaft.

In a feature of this aspect, the flow deflector extends forwardly away from the face of the mixing blade, the material flow being deflected toward the longitudinal axis during a pulling stroke of the mixing tool through material being mixed.

In a feature of this aspect, the opening of the mixing tool includes a top edge, a bottom edge, an inner edge, and an outer edge, wherein the outer edge is located further away from the longitudinal axis of the shaft than the inner edge, and wherein the flow defector is extends from the mixing blade face along the outer edge of the opening of the flow port deflector.

In a feature of this aspect, the face comprises a generally planar area.

In a feature of this aspect, the flow deflector is “V” shaped.

In a feature of this aspect, the flow deflector is triangular.

In a feature of this aspect, the flow deflector extends away from the mixing blade face at an angle less than 90° relative to the mixing blade.

In a feature of this aspect, an area of the flow deflector is substantially less than an area of the opening of the flow port.

In a feature of this aspect, the area of the flow deflector comprises between fifteen and sixteen square centimeters and the mixing blade comprises about two hundred and forty-eight square centimeters.

In a feature of this aspect, the mixing blade includes a generally planar area that is approximately orthogonal to the longitudinal axis of the shaft.

In a feature of this aspect, the mixing blade includes a generally planar area that defines a pentagonal perimeter of the generally planar area.

In accordance with another aspect of the invention, a mixing tool includes: an elongate shaft having a longitudinal axis; and a mixing blade located at an end of the shaft, the mixing blade having a bottom, a top, two sides, and a mixing blade face disposed therebetween. A plurality of flow ports each comprising an opening is disposed in the mixing blade face for flow therethrough of material being mixed by the mixing blade, each the flow port further comprising a flow deflector for deflecting material flow through the opening toward the axis of the shaft.

In a feature of this aspect, each the flow deflector extends forwardly away from the mixing blade face, the material flow being deflected toward the longitudinal axis during a pulling stroke of the mixing tool through material being mixed.

In a feature of this aspect, a first the flow deflector deflects material flow therethrough toward material flow deflected by a second the flow deflector, the first and second flow deflectors being arranged such that the material flows therethrough are convergent.

In accordance with an aspect of the invention, a mixing tool includes: an elongate shaft having a longitudinal axis; and a mixing blade located at an end of the shaft, the mixing blade having a bottom, a top, two sides, and a mixing blade face disposed therebetween. A flow port comprising an opening is disposed in the mixing blade face for flow therethrough of material being mixed by the mixing blade. Furthermore, the opening of the flow port is located on the mixing blade face closer to the bottom of the mixing blade than to the top of the mixing blade.

In a feature of this aspect, the opening of the flow port is between fifteen and sixteen square centimeters in area and is located about three centimeters from the bottom of the mixing blade. The mixing blade face further may include an area of approximately two hundred and forty-eight square centimeters, and the opening of the flow port may be located about two centimeters from a the side of the mixing blade.

In accordance with an aspect of the invention, a mixing tool includes: an elongate shaft having a longitudinal axis; and a mixing blade located at an end of the shaft, the mixing blade having a bottom, a top, and two sides. The top of the mixing blade includes a curved surface that curves in a direction toward the shaft, the curved surface corresponding approximately to a 45° arc, whereby material attempting to flow over the top of the mixing blade during a pulling stroke of the mixing tool is redirected back toward the approaching mixing blade.

In accordance with an aspect of the invention, a mixing tool includes: an elongate shaft having a longitudinal axis; a metal ferrule disposed in concentric surrounding relation with an end of the shaft; and a mixing blade located at an end of the shaft and connected to the metal ferrule. The metal ferrule extends about fifteen inches from the mixing blade along the shaft in covering relation to the shaft.

In a feature of this aspect, the shaft is made of wood.

In a feature of this aspect, the mixing blade includes a generally planar area that is approximately orthogonal to the longitudinal axis of the shaft.

In a feature of this aspect, the mixing blade is welded to the metal ferrule and wherein the metal ferrule is fastened to the shaft.

In accordance with an aspect of the invention, a mixing tool includes: an elongate shaft having first and second opposite ends and longitudinal axis extending therebetween; a mixing blade located at the first end of the shaft; and a cap mounted on and covering the second end of the shaft. The cap includes a gripping surface located in a radial direction further from the longitudinal axis than a gripping surface of the shaft, whereby greater torque is applied in rotating the shaft about the longitudinal axis by gripping and turning the cap than by gripping and turning the shaft.

In a feature of this aspect, the cap comprises a resilient, elastic material.

In a feature of this aspect, the cap has a proximal annular section and a distal annular section, the proximal annular section being located along the shaft closer to the mixing blade than the distal annular section, and the proximal annular section including a diameter that is greater than a diameter of the distal annular section.

In a feature of this aspect, the cap tapers from a proximal annular section thereof to a distal annular section thereof, the proximal annular section being located along the shaft closer to the mixing blade than the distal annular section

In accordance with yet another aspect of the invention, a mixing tool includes: an elongate shaft having a longitudinal axis; and a mixing blade located at an end of the shaft. The center of gravity of the mixing blade lies approximately along the longitudinal axis of the shaft.

In a feature of this aspect, the center of gravity of the mixing tool lies approximately along the longitudinal axis of the shaft.

In a feature of this aspect, the mixing blade includes a generally planar area that is approximately orthogonal to the longitudinal axis of the shaft.

In a feature of this aspect, the mixing blade includes a generally planar area that defines a pentagonal perimeter of the generally planar area.

In addition to the aforementioned aspects and features of the present invention, it should be noted that the present invention further includes the various possible combinations of such aspects and features.

### V. BRIEF DESCRIPTION OF THE DRAWINGS

Further aspects, features, embodiments, and advantages of the present invention will become apparent from the following detailed description with reference to the drawings, wherein:

Further aspects, features, embodiments, and advantages of the present invention will become apparent from the following detailed description with reference to the drawings, wherein:

FIG. 1 is a perspective view of a mixing tool in accordance with a preferred embodiment of the present invention;

FIG. 2 is a partial perspective view of on end of the mixing tool of FIG. 1;

FIG. 3 is another partial perspective view of the mixing tool of FIG. 1;

FIG. 4 is a partial side view of the mixing tool of FIG. 1; and

FIG. 5 is a partial top view of the mixing tool of FIG. 1.

### VI. DETAILED DESCRIPTION

As a preliminary matter, and for purposes of claim construction in the United States, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, one or more preferred embodiments of the present invention are next described.

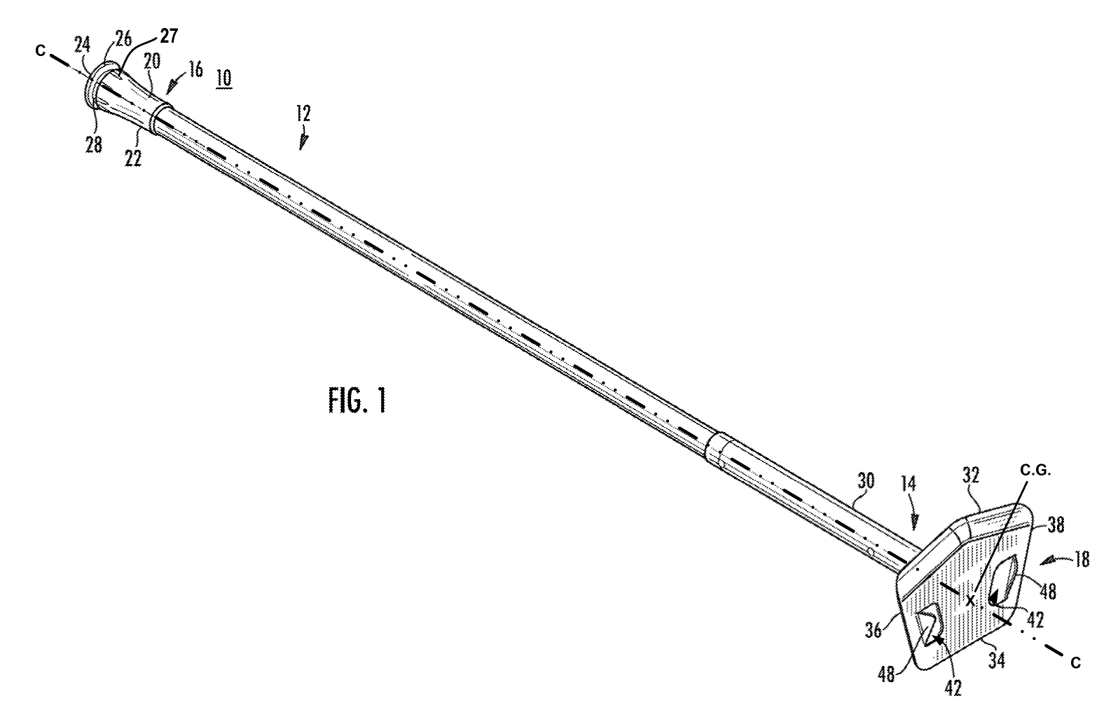

FIG. 1 is a perspective view of a mixing hoe—referred to herein as a mixing tool 10—in accordance with a preferred embodiment of the present invention. The mixing tool 10 includes an elongate shaft 12 having a blade end 14 and a user end 16, which may be grasped by a user for operation of the mixing tool 10. The blade end 14 includes a mixing blade 18, which is connected to the shaft 12 by a metal ferrule 30.

The mixing blade 18 is positioned relative to the shaft 12 such that a center of gravity (C.G.) of the mixing blade 18 (and preferably, the center of gravity of the entire mixing tool 10) is generally aligned with a longitudinal axis C of the shaft 12. Such alignment creates a weight balance in the mixing tool 10 that makes using tool 10 (especially rotating the shaft 12) significantly easier than a tool in which such weight balance is not present. The weight balance may be achieved by varying thicknesses in the mixing blade 18 and/or varying the materials or densities of different sections of the mixing blade 18, as required, in order to achieve the desired weight balance relative to the axis C of the shaft 12. The benefits of this weight balance are further discussed below.

The shaft 12 preferably is cylindrical and preferably is made of wood, although other materials may be used. The shaft 12 also may be generally between about three to six feet in length and, as illustrated, is about five to six feet in length.

The user end 16 of the shaft 12 is enclosed by an end cap 20 having a proximal annular section 22 and a distal annular section 24 relative to the blade end 14. The cap 20 is preferably made of a resilient, elastic material such as a rubber, and the cap 20 is generally tubular in shape with the distal annular section 24 being closed and the proximal annular section 22 being open so that the user end 16 of the shaft 12 may be inserted into an interior space defined by the cap 20 and thereby covered.

Furthermore, an outer diameter of the distal annular section 24 of the cap 20 preferably is larger than an outer diameter of the proximal annular section 22 of the cap 20 such that the cap 20 tapers inwardly along a direction from the distal annular section 24 toward the proximal annular section 22 (or, likewise, flares outwardly in a direction from the proximal annular section 22 to the distal annular section 24). An interior diameter of the cap 20 is slightly larger than an outer diameter of the shaft 12 such that the shaft 12 fits snuggly in frictional engagement with the cap 20 within the interior space of the cap 20. The distal annular section 24 of the cap 20 also preferably includes a rim 26 and longitudinally extending ribs 27 disposed about the circumference of the cap 20.

Optionally, a recessed portion 28 of the cap 20 also may extend adjacent the rim 26 and have a diameter that is smaller than that of the distal annular section 24 or the proximal annular section 22. The contoured profile of the cap 20—along with the rim 26, ribs 27, and recessed portion 28 of the cap 20, if provided—are believed to aid a user in maintaining a comfortable grip on the user end 16 of the shaft 12 when the mixing tool 10 is used. These features are also believed to reduce hand fatigue by aiding in rotation of the shaft 12 and mixing blade 18 during use of the mixing tool 10, as described in greater detail below.

The metal ferrule 30 is tubular shaped and covers the blade end 14 of the shaft 12. The ferrule 30 is connected to the blade 18, preferably by welding, and extends away from the blade 18 a predetermined distance along the length of the shaft 12. It is preferred that the ferrule 30 be formed from steel and be at least about fifteen inches in extent along the shaft 12. The metal ferrule 30 is mechanically affixed to the shaft 12. In the illustrated embodiment, mechanical fasteners comprising rivets secure the ferrule 30 to the shaft 12. The Ordinary Artisan will understand that many mechanical fasteners may be used for this connection, including, but not limited to, screws, bolts, and the like.

It is believed that the metal ferrule 30 is advantageous because it servers to protect the shaft 12 from damage during use of the mixing tool 10. For example, when the mixing tool 10 is used to mix material, the blade end 14 of the shaft 12 generally gets wet. Because the shaft 12 is wood, such continual wetting tends to weaken the shaft 12 and otherwise degrade it. The metal covering of the ferrule 30 sheaths the shaft 12 and protects it from getting wet. Furthermore, when the mixing tool 10 is cleaned after use, a chemical cleaner conventionally is used for removal of any hardened material left behind on the blade end 14 of the shaft 12. The ferrule 30 severs to protect the wooden shaft 12 from such chemicals, which otherwise would tend to damage and weaken the wooden shaft 12 over time.

Another advantage of the ferrule extending a significant extent up the shaft 12 is that, when a user is mixing materials with the mixing tool 10, it has been found that the user tends to knock the blade end 14 of the shaft 12 against an edge of a container in which the material is being mixed in order to remove from the blade end 14 excess material that tends to buildup. Such knocking would tend to damage and weaken the wooden shaft 12 over time. However, with the metal ferrule 30, a user can knock the mixing tool 10 using the metal ferrule 30 instead of the wooden shaft 12, thereby protecting the wooden shaft 12 from a direct beating and prolonging the useful life of the mixing tool 12 relative to other mixing tools that utilize only a wooden shaft 12.

In alternative embodiments, not shown, the shaft 12 and the ferrule 30 are replaced by a single steel shaft, with the shaft being welded directly to the mixing blade or, optionally, integrally formed with the mixing blade. This embodiment is believed to provide similar advantages to those discussed herein with regard to the steel ferrule 30.

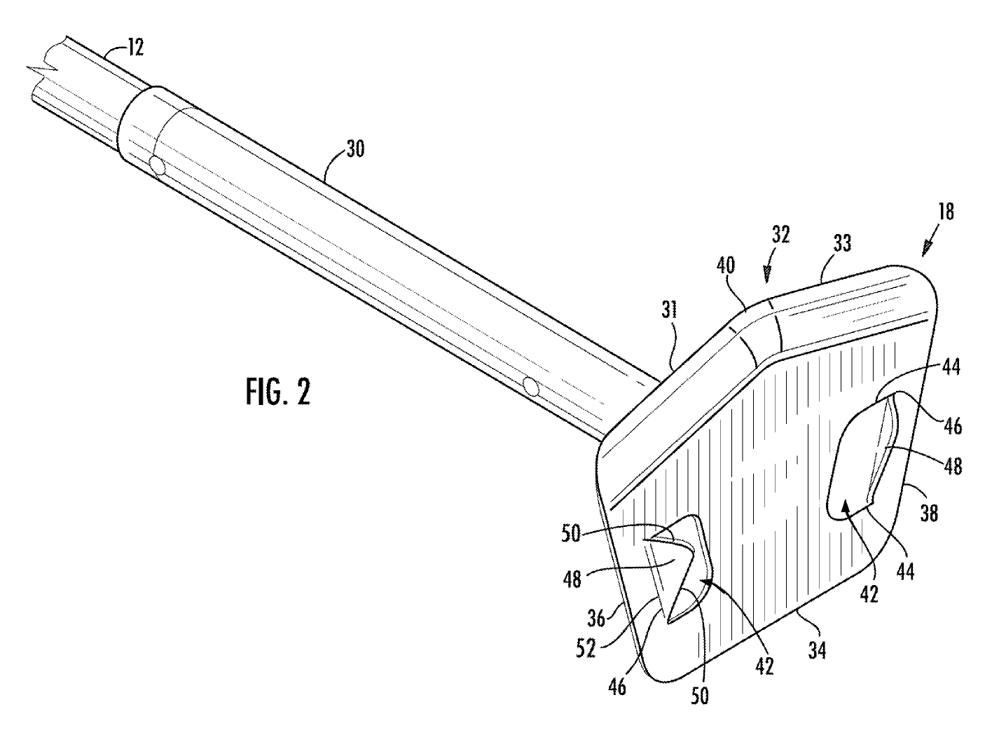

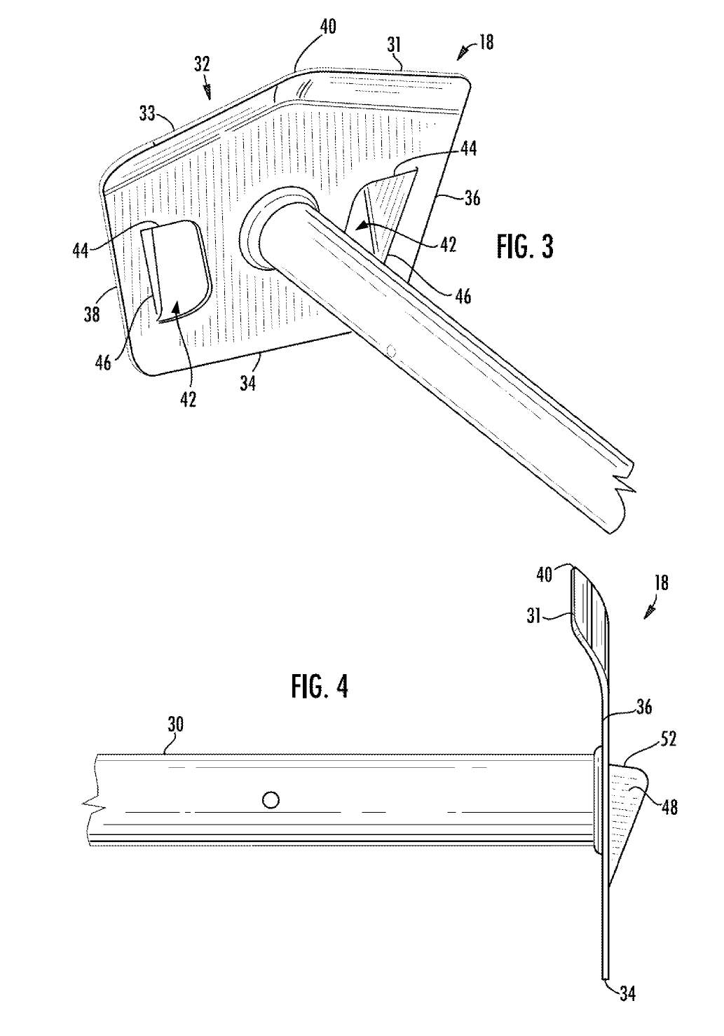

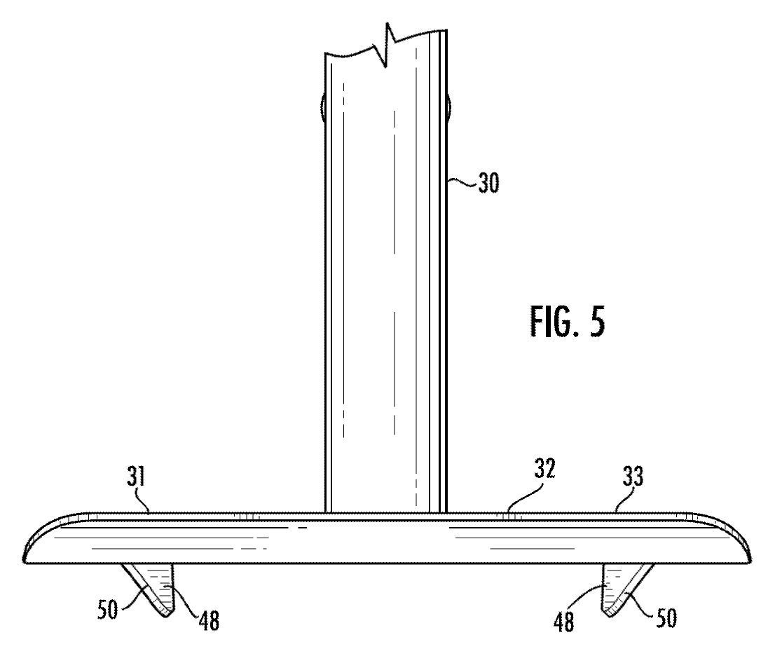

FIGS. 2-5 provide detailed partial views of the blade end 14 of the mixing tool 10. As best illustrated in FIGS. 4-5, a substantial portion of the mixing blade 18 includes a generally planar area. The mixing blade 18 further preferably includes a pentagonal periphery when viewed head-on along the axis C of the shaft 12. In this respect, the mixing blade 18 preferably includes: a top edge 32 comprised of a first edge section 31 and a second edge section 33; a bottom edge 34; a first side edge 36; and a second side edge 38. The first edge section 31 and the second edge section 33 preferably from an apex 40 of a pentagon proximate the middle of the top edge 32. The side edges 36,38 each extends from the top edge 32, at opposite ends thereof, to opposite ends of the bottom edge 34. Specifically, the first side edge 36 extends from an end of the first edge section 31 of the top edge 32 to an end of the bottom edge 34, and the second side edge 38 extends from an end of the second edge section 33 of the top edge 32 to the other, opposite end of the bottom edge 34.

Moreover, in extending from the top edge 32 to the bottom edge 34, the side edges 36,38 preferably taper inwardly. In this respect, it is preferred that an angle between each respective side edge 36,38 and the bottom edge 34 be between about 100° and about 115° and, more preferably, between about 100° and about 105°. The side edges 36,38 preferably intersect the top edge 32, i.e., intersect the first edge section 31 and the second edge section 33, respectively, at about 90°, which accommodates use of the mixing tool 10 with a mixing pan that, conventionally, has sidewalls that are perpendicular to its base.

The mixing blade 18 additionally preferably includes a curved section along the top edge 32. In particular, the first and second edge sections 31,33 preferably include a surface that curves or rolls out in a rearward direction toward the shaft 12. The curved portions of the first and second edge sections 31,33 preferably correspond to a 45° arc and are believed to aid in mixing when the mixing tool 10 is being used, in that material attempting to flow over the top edge 32 of the mixing blade 18 during a pulling stroke of the mixing blade 18 is redirected back toward the approaching mixing blade 18. This encourages material to instead flow through the flow ports 44 in the mixing blade 18 rather than over the top edge 32 of the mixing blade 18.

The mixing blade 18 includes flow ports 44 disposed in at least the substantially planar area of the mixing blade 18 for flow there through of material during a pushing or pulling stroke of the mixing tool 10 and, more preferably, during a pulling stroke of the mixing tool 10. In this regard, the exemplary mixing tool 10 includes two flow ports 44 comprising generally rectangular openings 42 that include rounded corners. Each opening 42 of the flow ports 44 has an area of about fifteen to sixteen square centimeters and, more preferably, approximately fifteen and one-half square centimeters. In contrast, the substantially planar area of the mixing blade 18 is approximately two hundred and forty-eight square centimeters, and the openings therefore represent approximately five percent to six percent of the generally planar area of the mixing blade 18.

Each opening 42 of the flow ports 44 is located about three centimeters from the bottom edge 34 of the mixing blade 18 and about two centimeters from a respective side edge 36,38 of the mixing blade 18. It should be noted that the openings 42 of the flow ports 44 are located closer to the bottom edge 34 than the top edge 32 and, preferably, the openings 42 of the flow ports 44 are located within the bottom half of the substantially planar area of the mixing blade 18. This location of the openings 42 of the flow ports 44 is relatively lower than the location of the flow ports disclosed in the mixing tool of the '881 patent, and it is believed that this lower disposition of the flow ports 44 in the mixing tool 10 facilitates more material flow when the mixing tool 10 is used because, during use of the mixing tool 10, a lesser extent of the mixing blade 10 itself needs to be submerged in the material in order to achieve material flow through the openings 42 of the flow ports 44.

In another feature of the present invention, each flow port 44 includes a material flow deflector 48. The flow deflectors 48 are the same and are attached to the mixing blade 18 in the same way and, therefore, only one will be described herein.

A flow deflector 48 is generally triangular in shape, having a base 52 and two sides 50. The flow deflector 48 may be formed by cutting out of the generally planar area of the mixing blade 18 slots that define the sides 50 of the flow deflector 48 and then bending the deflector along a hinge line 46. The flow deflector 48 of a flow port 44 is arranged (e.g., bent relative to the generally planar area of the mixing blade 18) such that the flow deflector 48 extends forwardly of the mixing blade 18 in a direction that is away from the ferrule 30. The flow deflector 48 furthermore preferably is disposed at an angle to the substantially planar area of the mixing blade 18 such that material flow through the flow port 44 during a pulling stroke of the mixing blade deflects the material flow toward another deflected material flow originating from another flow deflector 42. In this respect, the flow deflector 48 extends forwardly from the substantially planar area of the mixing blade 18 toward the center of the mixing blade 18 at an angle of between about 40° and 60°. More preferably, a flow deflector 48 extends at an angle of about 55° relative to the substantially planar area of the mixing blade 18.

In yet an additional feature relating to the flow ports 44, the surface area of a flow deflector 48 preferably is smaller than the area of the opening 42 of a flow port 44. Because the flow deflectors 48 extend forwardly and away from the mixing blade 18 (and thus away from the shaft 12), the flow ports 44 may tend to interfere with positioning of the front of the mixing blade near a wall of a container of the material being mixed. By limiting the area of the flow ports 44 and the distance forward by which the deflectors 48 extend from the mixing blade 18, such interference may be minimized while still providing effective deflection of the material flow.

In operation, the mixing blade 18 of the mixing tool 10 is inserted into a container of material to be mixed, such as a wheel barrow containing mortar. The mixing blade 18 then is forced through the material in the container.

The primary mixing movement of the mixing blade 18 may be forwardly, away from a user, during a pushing stroke of the mixing tool 10 through the material, with the mixing blade 18 being lifted for repositioning for another pushing stroke. However, it is preferred that the primary movement of the mixing blade 18 be rearwardly, toward a user, during a pulling stroke of the mixing tool 10 through the material, similar to a raking motion. It is believed that better control over the mixing tool 10 is achieved during a pulling stroke rather than during a pushing stroke. Additionally, it is believed that less fatigue results in a fixed period of time from pulling the mixing blade 18 through the material in the container as opposed to pushing the mixing blade 18 through the material in the container.

Moreover, during a pulling stroke of the mixing blade 18 through the material, flow of the material through one of the flow ports 44 is deflected into material flowing through another flow port due to the preferred orientation of the deflectors. This convergence of the deflected flows is believed to results in greater mixing action and turbulence in the material than the divergent deflection of the material flows as found, for example, in the mixing tool of the '881 patent. Additionally, divergent flows toward the sides of the container tend to result in accumulated buildup along the sidewalls of a container. In contrast, it is believed that the convergent material flows resulting from a pulling stroke of the mixing blade 18 results in less buildup along sidewalls of a container.

In moving the mixing blade 18 through the material, a user preferably places one hand on the cap 20 and the other hand midway or so along the shaft 12. The size and configuration of the cap 20 and, in particular, the aforementioned described features of the cap 20, are believed to make the gripping of the cap both comfortable and less wearing on the user's hand.

In use, the mixing tool 10 generally is maintained in an “upright” orientation wherein the apex 40 of the top edge 32 of the mixing blade 18 is oriented upwardly relative to the ground. However, the mixing blade 18 is reoriented from time to time in order to be used in getting close to—or scrapping a sidewall of—the container in which the mixing is occurring. Indeed, it is believed that the angled configuration of the mixing blade edges 32,34,36,38 allows the user to selectively use the edges 32,34,36,38 of the mixing blade 18 to scrape the sides of a container and, in particular, a wheel barrow, in order to remove any material from the sides or the bottom thereof. In reorienting the mixing blade, the shaft 12 is readily rotated about the longitudinal axis C due to the balanced weight of the mixing tool 10 and the greater torque and control provided by the increased circumference of the end cap 20.

In particular, in accordance with this intended use of the mixing tool 10, the hand gripping the cap 20 and, specifically, the increased diameter of the end 26 of the cap 20, is able to apply greater torque in rotating the shaft 12 about this axis C than the other hand of the user. Moreover, the balanced weight of the mixing blade 18 about the axis C of the shaft 12 results in the shaft 12 being generally “indifferent” to the direction of rotation of the shaft 12, i.e., the shaft 12 may be rotated in either direction with generally equal effort generally from any rotational position of the shaft 12. It is believed that this balanced weight of the shaft and indifference to directional rotation results in a lesser rate of fatigue during use of the mixing tool 18. It is further believed that the features described herein, including those relating to the end cap 20, may provide an improvement over the mixing tool of the '881 patent and may help to reduce hand fatigue above and beyond the reduction provided by the features in the mixing tool of the '881 patent.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. A mixing tool, comprising:
(a) an elongate shaft having a longitudinal axis; and
(b) a mixing blade located at an end of said shaft, said mixing blade having a bottom, a top, two sides, and a mixing blade face disposed therebetween;
(c) wherein a flow port comprising an opening is disposed in said mixing blade face for flow therethrough of material being mixed by said mixing blade, said flow port further comprising a flow deflector for deflecting material flow through said opening toward said axis of said shaft.

2. The mixing tool of claim 1, wherein said flow deflector extends forwardly away from said face of said mixing blade, the material flow being deflected toward said longitudinal axis during a pulling stroke of the mixing tool through material being mixed.

3. The mixing tool of claim 1, wherein said opening of said mixing tool includes a top edge, a bottom edge, an inner edge, and an outer edge, wherein said outer edge is located further away from said longitudinal axis of said shaft than said inner edge, and wherein said flow defector is extends from said mixing blade face along said outer edge of said opening of said flow port deflector.

4. The mixing tool of claim 1, wherein said face comprises a generally planar area.

5. The mixing tool of claim 1, wherein said flow deflector is “V” shaped.

6. The mixing tool of claim 1, wherein said flow deflector is triangular.

7. The mixing tool of claim 1, wherein said flow deflector extends away from said mixing blade face at an angle less than 90° relative to said mixing blade.

8. The mixing tool of claim 1, wherein an area of said flow deflector is substantially less than an area of said opening of said flow port.

9. The mixing tool of claim 1, wherein the area of said flow deflector comprises between fifteen and sixteen square centimeters and the mixing blade comprises about two hundred and forty-eight square centimeters.

10. The mixing tool of claim 1, wherein said mixing blade includes a generally planar area that is approximately orthogonal to the longitudinal axis of said shaft.

11. The mixing tool of claim 1, wherein said mixing blade includes a generally planar area that defines a pentagonal perimeter of the generally planar area.

12. The mixing tool of claim 1, wherein the center of gravity of the mixing blade lies approximately along the longitudinal axis of said shaft.

13. A mixing tool, comprising:
(a) an elongate shaft having a longitudinal axis; and
(b) a mixing blade located at an end of said shaft, said mixing blade having a bottom, a top, two sides, and a mixing blade face disposed therebetween;
(c) wherein a plurality of flow ports each comprising an opening is disposed in said mixing blade face for flow therethrough of material being mixed by said mixing blade, each said flow port further comprising a flow deflector for deflecting material flow through said opening toward said axis of said shaft.

14. The mixing tool of claim 13, wherein each said flow deflector extends forwardly away from said mixing blade face, the material flow being deflected toward said longitudinal axis during a pulling stroke of the mixing tool through material being mixed.

15. The mixing tool of claim 13, wherein a first said flow deflector deflects material flow therethrough toward material flow deflected by a second said flow deflector, said first and second flow deflectors being arranged such that the material flows therethrough are convergent.

16. A mixing tool, comprising:
(a) an elongate shaft having a longitudinal axis; and
(b) a mixing blade located at an end of said shaft, said mixing blade having a bottom, a top, two sides, and a mixing blade face disposed therebetween;
(c) wherein a flow port comprising an opening is disposed in said mixing blade face for flow therethrough of material being mixed by said mixing blade, said opening of said flow port being located on said mixing blade face closer to said bottom of said mixing blade than to said top of said mixing blade.

17. The mixing tool of claim 16, wherein said opening of said flow port is between fifteen and sixteen square centimeters in area and is located about three centimeters from said bottom of said mixing blade.

18. The mixing tool of claim 17, wherein said mixing blade face includes an area of approximately two hundred and forty-eight square centimeters

19. The mixing tool of claim 17, wherein said opening of said flow port is located about two centimeters from a said side of said mixing blade.

20. A mixing tool, comprising:
(a) an elongate shaft having a longitudinal axis; and
(b) a mixing blade located at an end of said shaft, said mixing blade having a bottom, a top, and two sides;
(c) wherein said top of said mixing blade includes a curved surface that curves in a direction toward said shaft, said curved surface corresponding approximately to a 45° arc, whereby material attempting to flow over said top of said mixing blade during a pulling stroke of the mixing tool is redirected back toward the approaching mixing blade.
